(19) United States
(12) Patent Application Publication
(10) Pub. No.: US 2017/0353872 A1
(43) Pub. Date: Dec. 7, 2017

(54) METHOD AND DEVICE FOR DEVICE CONFIGURATION

(71) Applicant: THOMSON LICENSING, Issy-Les-Moulineaux (FR)

(72) Inventor: Wei HUANG, Beijing (CN)

(21) Appl. No.: 15/537,481

(22) PCT Filed: Dec. 19, 2014
(86) PCT No.: PCT/CN2014/094318

§ 371 Date: Jun. 19, 2017

(51) Int. Cl. H04W 24/02; H04L 12/24; H04W 8/22; H04W 88/06

(52) U.S. Cl. CPC H04W 24/02; H04W 8/22; H04L 41/0813; H04W 88/06

(57) ABSTRACT

It is provided a method for device configuration, wherein at side of a device comprising working in STA mode (402); and if determining that the device can't connect to any one of detected AP devices, changing to AP mode (406).

### TECHNICAL FIELD

The present disclosure relates to network, and more particularly relates to a method and a device for device configuration.

### BACKGROUND

Over-the-top content (OTT) refers to delivery of audio, video, and other media content over the Internet without the involvement of a multiple-system operator in the control or distribution of the content. The Internet provider may be aware of the contents of the Internet Protocol packets but is not responsible for, nor able to control, the viewing abilities, copyrights, and/or other redistribution of the content. Current OTT boxes often have a hardware remote control device (i.e. remote controller), and some OTT boxes also provide a remote control application to be installed on users' smart phone or tablet. Some OTT boxes require users to configure the network parameters so as to connect the OTT boxes to the content server or Internet.

It is desired a method for configuring the OTT boxes.

### SUMMARY

According to an aspect of the present disclosure, it is provided a method for device configuration, wherein at side of a device comprising working in STA mode; and if determining that the device can't connect to any one of detected AP devices, changing to AP mode.

According to another aspect of the present disclosure, it is provided a method for device configuration, wherein comprising a connection interface module configured to work in STA mode; and a control module configured to make the connection interface module change to AP mode if determining that the connection interface module can't connect to any one of detected AP devices.

It is to be understood that more aspects and advantages of the invention will be found in the following detailed description of the present invention.

### BRIEF DESCRIPTION OF THE DRAWINGS

The accompanying drawings, which are included to provide a further understanding of the invention and are incorporated in and constitute a part of this application, will be used to illustrate an embodiment of the invention, as explained by the description. The invention is not limited to the embodiment.

In the drawings:

FIG. 1 is a block diagram showing an example of a system for providing a service to a user according to the embodiment of the present disclosure;

FIG. 2 is a block diagram showing a hardware configuration of the OTT box according to the embodiment of the present disclosure;

FIG. 3 is a detailed block diagram showing the CPU according to the embodiment of the present disclosure;

FIG. 4 is a flow chart showing a method for configuring an OTT box according to the embodiment of the present disclosure;

FIG. 5 is a flow chart showing a first implementation of the determination step according to the embodiment of the present disclosure; and

FIG. 6 is a flow chart showing a second implementation of the determination step according to the embodiment of the present disclosure.

### DETAILED DESCRIPTION

The embodiment of the present disclosure will now be described in detail in conjunction with the drawings. In the following description, some detailed descriptions of known functions and configurations may be omitted for clarity and conciseness.

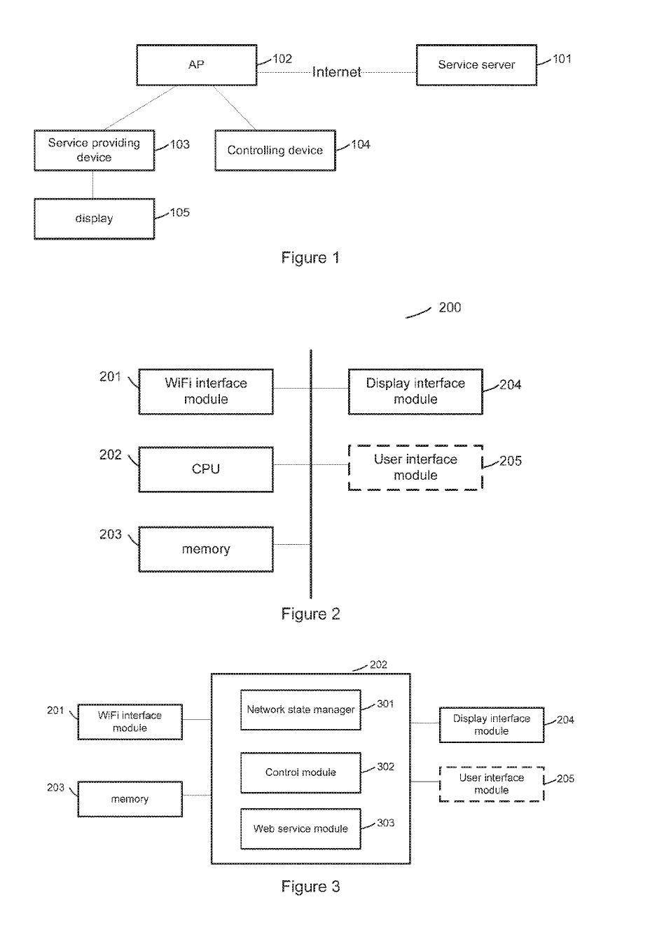

The present disclosure discloses a method of configuring a service-providing device at the user end, such as OTT box, by a controlling device (e.g. tablet, phone, computer, and laptop). The service-providing device switches between an AP (Access Point) mode and a STA (Station) mode automatically based on the availability of its Wi-Fi configuration to one or more detected Wi-Fi AP. When the service-providing device has a valid Wi-Fi configuration for a detected Wi-Fi AP (i.e. it successfully connects to the Wi-Fi AP), it switches to the STA mode. If not, the service-providing device switches to the AP mode. In the AP mode, the controlling device connects to the service-providing device directly, and uses a browser, e.g. Internet Explorer, to browse and configure parameters of the service-providing device. In the STA mode, the controlling device connects to the service-providing device via the Wi-Fi AP. In other words, both the service-providing device and the controlling device work in the STA mode and connect to the Wi-Fi AP. The user uses the remote control functions provided on HTML pages that are accessed on the controlling device (via the URL on the browser) to control or configure the service-providing device. FIG. 1 is a block diagram showing an example of a system for providing a service to a user according to the embodiment of the present disclosure.

The system comprises a service server 101, an AP 102, a service providing device 103, a controlling device 104 and a display 105. The service server 101 provides a service, e.g. a Video on Demand (VoD) content. The AP 102, the service providing device 103, the controlling device 104 and the display 105 are at the user end in terms of geographical location. The AP 102 connects to the service server 101 via the Internet. The service providing device 103 connects in a wireless manner to the AP 102, and connects to a display 105 for display the service and other information. The controlling device 104 connects in a wireless manner to the AP 102, and controls the service providing device via a HTML page provided by the service providing device 103.

Below is an example describing an embodiment of the present disclosure within the context of OTT service. With implementation of this solution, the OTT box switches between the AP mode and the STA mode automatically. And the related information is displayed on a TV or a display to which the OTT box is connected. A user opens a browser (or scan a QR code on the TV screen to get the URL) on their smart phone or tablet to configure or control the OTT box. FIG. 2 is a block diagram showing a hardware configuration of the OTT box according to the embodiment of the present disclosure.

The OTT box 200 comprises a wifi interface module 201, a CPU (central processing unit) 202, a memory 203, and a display interface module 204. And optionally, the OTT box 200 can have a user interface module 205.

The wifi interface module 201 is hardware to perform an IEEE 802.11 a/b/g/n function (comprising scanning for nearby AP(s)), and may communicate with a main board, on which the CPU 202 is mounted, via a universal serial bus. The wifi interface module 201 supports both AP mode and STA mode (also called infrastructure mode and Ad hoc mode) and can switch mode during operation. In STA mode, the wifi interface module 201 operates as an AP client that is able to connect to a wifi AP and is able to link to an existing wireless network. In AP mode, the wifi interface module 201 acts as an AP host that allows other wifi adapters (i.e. AP clients) to connect to it. There are existing wifi chipsets allowing mode switch and providing program interface for mode switch.

The CPU (central processing unit) 202 controls overall operations based on instructions and data stored in the memory 203.

The memory 203 may include a random access memory (RAM) and a read only memory (ROM). The memory 203 is used to store data (e.g. values of wifi configuration parameters) and computer program instructions.

The display interface module 204 is used to connect to the display 105 and output video signals to the display 105.

The user interface module 205 is used to indicate a) on which mode between AP mode and the STA mode the wifi interface module 201 is working and b) state of wifi connection of the OTT box. For example, the user interface module is LED indicators on the panel of the OTT box 200.

Hereinafter, a method for configuring the OTT box is described with reference to FIG. 2 and FIG. 3. FIG. 2 is a hardware configuration diagram, and FIG. 3 is a detailed block diagram showing the CPU 202 according to the embodiment of the present disclosure. The CPU 202 may include a network state manager 301, a control module 302 and a web service module 303.

The network state manager 301 is used to monitor state of Wifi connection and display the state information about whether or not the wifi interface module has connected to an operating AP and about which operating AP on the display 105 via the display interface module 204 and/or on the user interface module 205.

The control module 302 is used to control mode of the wifi interface module 201.

The web service module 303 is used to generate web page for controlling or configuring the OTT box, receive requests inputted on the web page and carry out corresponding instructions on the OTT box. The web page is displayed on the browser of the user's controlling device.

According to a variant embodiment, the web service module 303 does not generate web page. It is used to receive instructions, e.g. messages or instructions encapsulated in IP packets from the controlling device.

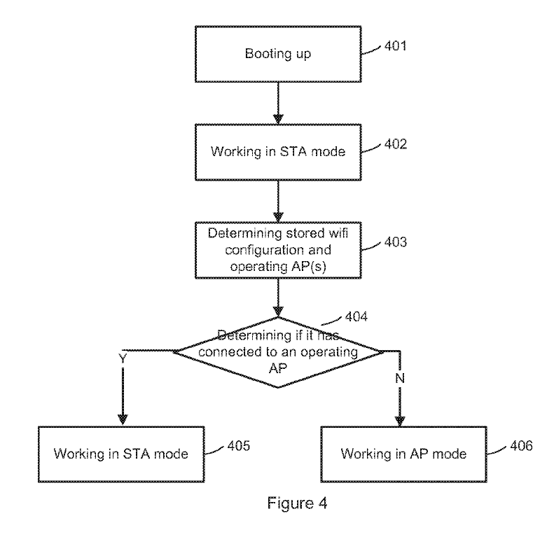

FIG. 4 is a flow chart showing a method for configuring an OTT box according to the embodiment of the present disclosure.

In the step 401, the OTT box boots up, and the network state manager 301, the control module 302 and the web service module 303 work as daemon process.

In the step 402, the wifi interface module 201 is configured to work in STA mode.

In the step 403, the network state manager 301 determines stored (or pre-configured, existing) wifi configuration in the memory 203 and determines nearby operating AP(s). ‘Operating’ here means that the AP is in a working state or an operating state. The wifi configuration is made up of wifi configuration items. Each item comprises at least 3 data fields for SSID (service set identifier), network type (including WEP, WPA/WPA2 and no encryption) and password. For an item whose network type is ‘no encryption’, its password is void. Then the wifi interface module 201 tries to connect the determined operating AP(s) with the stored wifi configuration.

In the step 404, the network state manager 301 determines if the wifi interface module 201 successfully connects to one of the determined operating AP(s) with the stored wifi configuration. In other words, it determines if the wifi interface module 201 can successfully connect to one encrypted operating AP with one stored wifi configuration item or one non-encrypted operating AP. If the result is positive, it goes to the step 405. And if the result is negative, it goes to the step 406. In an extreme case that there is no operating AP, the determination result is that the wifi interface module 201 does not connect an AP. So it goes to the step 406.

In the step 405, the wifi interface module 201 remains working in STA mode. According to another variant, if it has user interface module 205, it uses a LED indicator to indicate it is working in STA mode. In an embodiment, an URL (uniform resource locator) of a web page for controlling the OTT box (e.g. to change the media content etc.) is shown by the display interface module on the display 105. The web page is generated by web service module 303. In another embodiment, a QR code (quick response code, it is a type of matrix barcode or two-dimensional barcode) for accessing a web page for controlling the OTT box is used and shown on the display 105. The user can use the controlling device to scan the QR code so as to access the web page. Herein, the QR code is generated by encoding the URL by some QR code generator.

In the step 406, the wifi interface module 201 is changed to work in AP mode and wait for connection request from the controlling device. According to another variant, if it has user interface module 205, it uses a LED indicator to indicate it is working in AP mode. In order to enable the controlling device to connect to the wifi interface module 201, the display interface module outputs a signal including information for the controlling device to connect to the wifi interface module. In an embodiment, the information comprises an URL (uniform resource locator) of a web page for configuring parameters of the OTT box (e.g. wifi configuration for AP(s)), SSID, network type and password if the wifi interface module 201 is encrypted in AP mode. The information is shown by the display interface module on the display 105. The web page is generated by web service module 303. The user uses the SSID, network type and password to connect the controlling device to the wifi interface module 201, and then uses the URL to access the web page for configuring parameters for the purpose of enabling to connect to an AP. In another embodiment, a QR (quick response) code for connecting to the wifi interface module 201 and a QR code for accessing a web page for configuring parameters of the OTT box are used and shown on the display 105. The user can use the controlling device to scan the two QR code in sequence so as to connect to the wifi interface module and access the web page. The wifi interface module 201 accepts the connection request after verification and waits to receive input of configuration parameters. After the user uses the controlling device to finish configuration for the AP (e.g. an “OK” button is clicked in a web page for the user to input SSID, network type and password for the AP), the memory 203 stores the input, and the wifi interface module 201 is changed to work in STA mode and connects to the AP. Moreover, the controlling device disconnects with the wifi interface module 201 and connects to the AP. And then it can uses the URL or the QR code, which is displayed on the display 105, to control the OTT box.

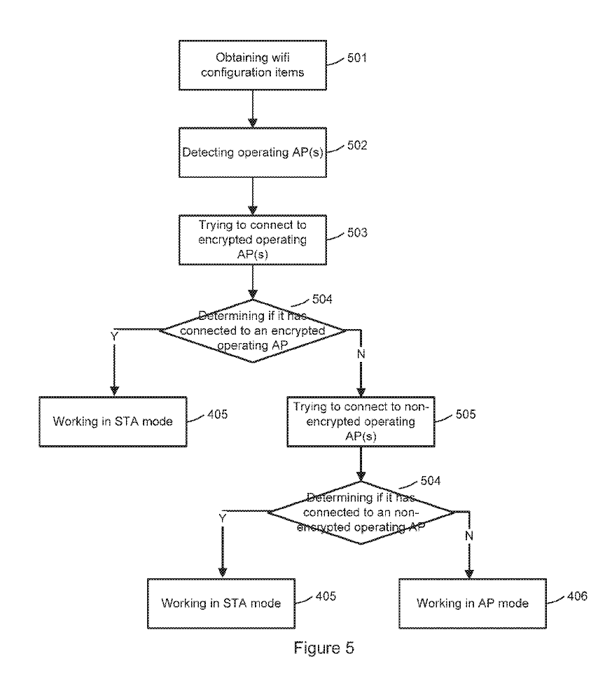

As to the determination, FIG. 5 is a flow chart showing a first implementation of the determination step according to the embodiment of the present disclosure. In the step 501, the network state manager obtains wifi configuration items from the memory 203. In the step 502, the networks state manager detects operating AP(s). In the step 503, for each of detected operating AP(s) with encryption, it uses wifi configuration item that has the same SSID as the operating AP to try to connect the operating AP. But the iteration is stopped if it can connect to an operating AP. In the step 504, the network state manager determines if the wifi interface module connects to one detected operating AP with encryption. If positive, it goes to the step 405. If negative, it tries to connect to detected AP without encryption in the step 505. In the step 506, the network state manager determines if the wifi interface module connects to one detected operating AP without encryption. If positive, it goes to the step 405. If negative, it goes to the step 406. Herein, optionally, in the steps 503 and 505, the detected AP(s) are assigned a priority in the order of signal strength. The priority is used for order of connection.

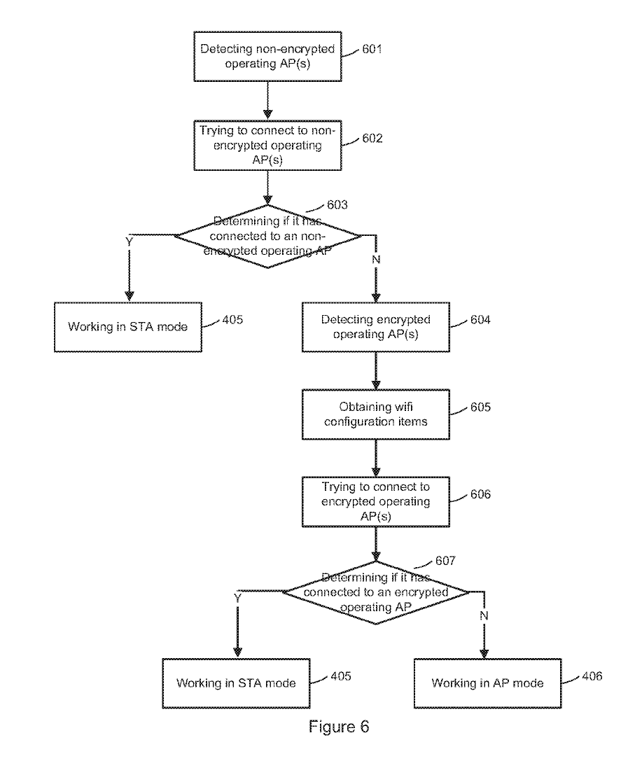

As to the determination, FIG. 6 is a flow chart showing a second implementation of the determination step according to the embodiment of the present disclosure. In the step 601, the networks state manager detects operating AP(s) without encryption. In the step 602, the network state manager tries to connect to detected AP without encryption. In the step 603, the network state manager determines if the wifi interface module connects to one detected operating AP without encryption. If positive, it goes to the step 405. If negative, it detects operating AP(s) with encryption in the step 604. In the step 605, the network state manager obtains wifi configuration items from the memory 203. In the step 606, for each of detected operating AP(s) with encryption, it uses wifi configuration item that has the same SSID as the operating AP to try to connect the operating AP. In the step 607, the network state manager determines if the wifi interface module connects to one detected operating AP with encryption. If positive, it goes to the step 405. If negative, it goes to the step 406. According to a variant embodiment, it can detect all operating AP(s) in the step 601. And in this case, the step 604 is redundant.

It shall be noted that FIG. 5 and FIG. 6 just give two implementations of the determination step, and a person skilled in the art can revise the two implementations to obtain other implementations.

Computer program product downloadable from a communication network and/or recorded on a medium readable by computer and/or executable by a processor, comprises program code instructions for implementing the steps of the method as described above.

Non-transitory computer-readable medium comprising a computer program product recorded thereon and capable of being run by a processor, includes program code instructions for implementing the steps of the method as described above.

Although above embodiments are described with reference to service-providing device, i.e. OTT box, it shall be noted that it can also be applied to other network device, which can switch between STA mode and AP mode and whose working mode is STA mode when providing services.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application and are within the scope of the invention as defined by the appended claims.

1. A method for a device configuration, wherein the device works in a station mode, the method comprising
changing an operation of the device to an access point mode if the device can't connect to any one of detected access points; and
outputting a signal including information for a controlling apparatus to connect to the device operating in the access point mode.

2. The method of claim 1, further comprising
determining if the device can connect to any one of detected access points.

3. The method of claim 2, wherein the determining further comprises
obtaining at least one stored configuration item, wherein a configuration item is used to connect to an access point;
using the at least one stored configuration item to connect to an access point; and
determining if the at least one stored configuration item can be used to connect to the detected access points.

4. (canceled)

5. The method of claim 1, further comprising
establishing a connection with the controlling apparatus;
receiving configuration parameters for an access point;
storing the configuration parameters as a configuration item; and
changing to the station mode.

6. A device for device configuration, comprising
a connection interface module, a control module and a display interface module, wherein
the connection interface module is configured to work in a station mode; and
the control module is configured to make the connection interface module change to an access point mode if the connection interface module cannot connect to any one of detected AP devices access points, and
the display interface module is configured to output the signal including information for a controlling apparatus to connect to the connection interface module in the access point mode.

7. The device of the claim 6, further comprising
a state manager configured to determine if the connection interface module can connect to any one of detected access points.

8. The device of the claim 7, further comprising
a memory configured to store at least one configuration item, wherein a configuration item is used to connect to an access point;
the state manager further configured to obtain the at least one configuration item from the memory, use the at least one configuration item to connect to the access point, and determine if the at least one configuration item can be used to connect to the access point.

9. (canceled)

10. The device of claim 6, wherein
the connection interface module is further configured to establish a connection with the controlling apparatus;
the state manager is further configured to receive configuration parameters for an access point and store the configuration parameters as a configuration item in the memory; and
the control module further configured to change to the station mode.

11. A computer program product downloadable from a communication network and/or recorded on a medium readable by computer and/or executable by a processor, comprising program code instructions for implementing steps of the method of claim 1.

12. A non-transitory computer-readable medium comprising a computer program product including program code instructions for implementing steps of the method of claim 1.
